(19) United States
(12) Patent Application Publication
(10) Pub. No.: US 2007/0180969 A1
(43) Pub. Date: Aug. 9, 2007

(54) Punch device

(76) Inventors: Yoshihito Kanasashi, Tokyo (JP); Naoki Ozawa, Tokyo (JP); Hiroyuki Urabe, Kanagawa (JP); Ayano Yamashita, Tokyo (JP)

Correspondence Address: EVEREST INTELLECTUAL PROPERTY LAW GROUP, P. O. BOX 708, NORTHBROOK, IL, 60065, US

(21) Appl. No.: 10/590,259

(22) PCT Filed: Jan. 27, 2006
(86) PCT No.: PCT/JP06/01333

§ 371 Date: Aug. 18, 2006

(30) Foreign Application Priority Data
Feb. 15, 2005 (JP) 2005-037691

(51) Int. Cl. B26F 1/14

(52) U.S. Cl. 83/684

(57) ABSTRACT

A punch device includes a punch 1 and a punch auxiliary tool 3. The punch 1 includes a punch station 10 formed with a guide hole 12 and a slit 11 into which a sheet is inserted, a punching blade 13 to be guided in the guide hole, an operating section 15 for operating the punching blade, and a housing 20 having an opening 25 in which the operating section is disposed. The punch auxiliary tool 3 includes arms 36 rising from both sides of the station 30, and a pressing operating member 40 pivotally supported by the arms. An inserting/detaching opening 31 for inserting and detaching the punch is provided on a side where the pressing operating section is pivotally supported. A lower surface of the pressing operating member of the punch auxiliary tool is provided with a pressing section 41 which presses the operating section of the punch inserted from the inserting/detaching opening. With this, the punch can be attached and detached from the side opposite to the pressing operating section, and the operation can be carried out efficiently. Further, the structure of the punch can be made compact.

### TECHNICAL FILED

The present invention relates to a punch device for punching a hole of a desired shape in a sheet material such as paper, cloth and synthetic resin, or forming a cut-out piece of a desired shape.

### BACKGROUND ART

To facilitate the punching operation by a punch, there conventionally exist various punch devices in which a punch and an auxiliary tool are combined with each other.

As a punch device of this kind, a patent document 1 discloses a punch device in which an assembly of die and punch can be changed with respect to a base, and holes of different shapes can be punched. The punch device has a punch outer case body, the punch outer case body including a base having an opening, a cap fixed on the base at predetermined distances from the base, and actuator buttons slidably disposed in the cap. The assembly of the die and the punch is inserted into the cap and the actuator button through the opening from a lower portion of the base, the assembly is fixed to a predetermined position, and the actuator button is pressed, thereby punching a hole in a paper.

In addition, if many punches capable of punching holes of various shapes such as star shape, flower shape and the like are prepared and those punches are exchanged and attached to the punch outer case body, it is possible to punch holes of various shapes.

A patent document 2 discloses a puncher main body including a base, a support arm rising from the base, a guide connected to a tip end of the support arm, a pressing portion having an arm which is vertically movably connected to the support arm, and a movable portion which is movably inserted into the guide. Various puncher bases and punching portions are designed so as to be attachable to and detachable from the puncher main body, whereby this puncher can punch holes of various designs such as papers.

A patent document 3 discloses a paper punch in which a punch assembly in which an inner punch, an outer punch, a punch base and the like are accommodated is constituted so as to be attachable to and detachable from a base on which a handle is slidably mounted, and the punch assemblies each having various shape punching blades are exchanged and used. According to this paper punch, the punch assembly can be attached to and detached from the base by bringing up the handle further from a normal position.

A patent document 4 discloses a punching operating tool capable of punching a hole by pressing a punch positioned by a template fixed on the base by means of a lever utilizing a punching operating tool having a lever which is slidably pivotally mounted on the base.

Meanwhile, when it is required to punch holes at equal distances from one another, or to form holes having continuous patterns, a patent document 5 discloses a punch device for forming a pattern using a combination of a punch with a plate having a positioning marker.

According to the punch device for forming a pattern, a punch having a punching blade having the same cross section shape as that of the marker punches a hole, and then the sheet is deviated in position, the hole formed in the sheet is superposed on the positioning marker, a hole is punched further, and holes having desired patterns are continuously formed at equal distances from one another.

Patent Document 1: Japanese Patent Application Laid-open No. 8-229896

Patent Document 2: Japanese Patent Application Laid-open No. 2002-239994

Patent Document 3: U.S. Pat. No. 6,089,137

Patent Document 4: U.S. Pat. No. 6,145,425

Patent Document 5: U.S. Patent Application Laid-open No. 2003/0037657

### DISCLOSURE OF THE INVENTION

### Problem to be Solved by the Invention

According to the punch tool described in the patent document 1, since the assemblies each including the die and the punch can be exchanged, it is possible to punch holes of different shapes. However, since it is necessary to directly press the actuator button projecting upward, sheet materials to be punched are limited. Further, in order to punch holes having a plurality of complicated shapes and a plurality of patterns at once, relatively large pressing force is required and thus, it is difficult for a small child having a weak force to use the punch tool.

According to the puncher disclosed in the patent document 2, since the puncher base and the punching portion can be attached to and detached from the puncher main body, it is possible to punch holes of different shapes. However, since the arm having the support arm and the pressing section project from the base upward, the puncher is increased in size.

In addition, the puncher base and the punching portion must be mounted separately on the base and the movable portion respectively and thus, a general punch can not be used.

The paper punch disclosed in the patent document 3 can form holes of desired patterns by exchanging the punch assemblies However, when the punch assembly is to be exchanged, the handle must be brought higher than a normal using position and thus, the exchanging operation of the punch assembly becomes troublesome.

The punch operation tool disclosed in the patent document 4 can punch holes of desired patterns by exchanging the punch. However, the pivot portion of the handle and the pressing section of the punch are separated from each other. Therefore, in order to design the punch operation tool so as to be able to punch holes with a small pressing force, the handle must be long and the tool becomes large in size.

In addition, when the punch is to be exchanged, it is necessary to bring the handle up and to dispose the punch such that the punch is aligned with the proper position, so that the exchanging operation of the punch is troublesome.

According to the punch device for forming patterns described in the patent document 5,it is difficult to punch holes with a weak pressing force like the device described in the patent document 1. Further, since it is necessary to align the hole formed in the sheet and the marker while checking them with eyes, it is difficult to align and a beautiful continuous pattern can not be formed in some cases.

Especially when paper craft or the like is to be produced, many punches having punching blades of various shapes must be prepared, the punch must be attached to the auxiliary tool while exchanging the punch for another punch, and a sheet is inserted into a slit of the punch and the punching operation must be repeated. Therefore, a series of operations, such as operation for attaching the punch to the auxiliary tool while exchanging the punch for another punch, operation for inserting a sheet into a slit of the punch and aligning them, and operation for punching holes, can not be carried out smoothly, it takes time for manufacturing the paper craft, and motivation for creation is attenuated.

In order to make craft in a craft classroom or a home where operation is carried out in a limited space enjoyable, a compact punch device which does not occupies large accommodation space or operation space has been desired.

Hence, it is an object of the present invention to provide a punch device capable of smoothly carrying out a series of operations in a craft site using a punch, and reducing the operation space and the accommodation space.

Means for Solving Problem

To achieve the above object, the present invention provides a punch device including: a punch including a punch station formed with a slit into which a sheet to be punched is to be inserted and a guide hole for guiding a punching blade in a direction intersecting with the slit, the punching blade to be guided into the guide hole, an operating section for operating the punching blade, and a housing which accommodates the punch station and the punching blade and which is formed with an opening in which the operating section is disposed; and a punch auxiliary tool having a pair of arms rising from opposite sides of the station and a pressing operating member which is pivotally supported by the arms, wherein an inserting/detaching opening for inserting and detaching the punch is formed on a side where the pressing operating section is pivotally supported, a lower surface of the pressing operating member of the punch auxiliary tool is provided with a pressing section which presses the operating section of the punch inserted from the inserting/detaching opening.

In the invention, the punch may have a configuration in which, in a state where the operating section of the punching blade is disposed in the opening of the housing, the punch station and the punching blade are accommodated in the housing such that the operating section of the operating section is substantially flush with an upper surface of the housing.

The punch may have a guide wall suspending from a periphery of the opening of the housing for guiding the operating section of the punching blade.

The station of the punch auxiliary tool may be provided with a holding portion for holding the punch disposed below the pressing section of the pressing operating member.

The punch device may further include a positioning tool including a mounting stage on which a sheet to be punched is placed, and sheet holding means for holding the sheet to be punched placed on the mounting stage, a to-be-retained portion provided on the punch or punch auxiliary tool is engaged with a retaining portion provided on the positioning tool, and a punching position in the sheet to be punched may be set.

A ruler member may be mounted on a mounting stage of the positioning tool, the ruler member may include a ruler portion against which an end edge of the sheet to be punched can abut, the ruler member can turn toward its back surface from a position where a surface of the mounting stage is substantially flush, the end edge of the mounting stage which is exposed when the ruler member is turned toward the back surface of the mounting stage may be provided with the retaining portion.

A plurality of the retaining portion may be provided along the end edge of the mounting stage at equal distances from one another.

A retaining position of the to-be-retained portion which is engaged with the retaining portion may be changed selectively.

### EFFECT OF THE INVENTION

According to the punch auxiliary tool of the punch device in the present invention, the inserting/detaching opening is provided on the side where the pressing operating member is pivotally supported. Therefore, the punch can be mounted from a side opposite to the side where the pressing operation is carried out.

With this, the punch can be mounted only by one action, i.e., only by inserting the punch into the inserting/detaching opening of the punch auxiliary tool. Since it is unnecessary to lift the pressing operating member to mount the punch or remove the outer case of the punch auxiliary tool to mount the punch, troublesome of attaching and detaching the punch is overcome.

It is possible to punch a hole by mounting the punch on the punch auxiliary tool using one hand, inserting the sheet to be punched into the punch and then operating the pressing operating member of the punch auxiliary tool using the other hand. Therefore, the series of operations can be carried out smoothly, and the operation time is shortened.

Further, the pressing section (point of lever which applies force) is located between the pivot portion of the pressing operating member (fulcrum) and the pressing operating section (point of lever where force is applied). Therefore, it is possible to realize the principle of leverage with a compact device, and the operation space and accommodation space can be reduced.

The height of the operating section of the operating section of the punch is substantially the same as the height of the upper surface of the housing. Thus, the punch itself can be reduced in size, and the point of lever which applies force of the pressing operating member of the punch auxiliary tool can be brought closer to the fulcrum.

With this, a distance between the fulcrum and the point of lever where force is applied can be shortened, the punch auxiliary tool can be reduced in size, and it is possible to operate the punch with smaller pressing force.

The operating section of the punch does not project. Therefore, when the punch is used as a discrete device, it is possible to prevent the operating section from being pushed unintentionally.

The guide wall is suspended from the periphery of the opening of the housing of the punch. The guide wall guides the operating section of the punching blade. With this, it is possible to precisely guide the punching blade and the operating section. Since no gap is formed between the operating section and the opening of the housing, there is no possibility that a finger is caught in the gap, and safety when the punch is used alone can be enhanced.

If the station of the punch auxiliary tool is provided with the holding portion for holding the punch, the punch and the punch auxiliary tool can be integrally coupled to each other. Thus, the punch device can be handled with one hand.

The punch device may further include the positioning tool including the mounting stage on which the sheet to be punched is placed, and the sheet holding means for holding the sheet to be punched placed on the mounting stage. With this, the punch device has the positioning function.

In this case, the to-be-retained portion provided on the punch or punch auxiliary tool is engaged with the retaining portion provided on the positioning tool in a state where the sheet to be punched is held by the mounting stage. Therefore, it is possible to prevent the sheet to be punched from being deviated.

The ruler member having the ruler portion against which the end edge of the sheet to be punched can abut may be mounted on the mounting stage of the positioning tool. With this, it is possible to precisely set the length from the end edge of the sheet to be punched to the punching portion. After the alignment is completed, the ruler member is turned and retracted from a position where the ruler member is substantially flush with a surface of the mounting stage toward the back surface. Thus, the ruler member does not hinder when the sheet to be punched is inserted into the slit of the punch.

When the retaining portions of the positioning tool are provided along the end edge of the mounting stage at equal distances from one another, holes are punched while deviating the punch and the punch auxiliary tool along the end edge of the mounting stage and while sequentially engaging the to-be-retained portion and the retaining portion of the positioning tool. With this, it is possible to punch holes along the end edge of the sheet to be punched at equal distances from one another.

With this, it is possible to continuously form holes having predetermined shapes at equal distances from one another, and it is possible to form lace-like edge decoration in the sheet to be punched.

If the retaining position of the to-be-retained portion of the punch or punch auxiliary tool which is to be engaged with the retaining portion can be changed selectively, it is possible to appropriately change the distance between holes.

### BRIEF DESCRIPTION OF THE DRAWINGS

FIG. 1 is a perspective view showing a punch device according to a first embodiment.

FIG. 2 is a sectional view taken along the line A-A in FIG. 1.

FIG. 3 is a perspective view showing a punch of the punch device.

FIG. 4 is a front view of the punch.

FIG. 5 is a sectional view taken along the line B-B in FIG. 4.

FIG. 6 is a perspective view showing a punch auxiliary tool.

FIG. 7 is a side view of the punch auxiliary tool.

FIG. 8 is a bottom view of the punch auxiliary tool.

FIG. 9 is a side sectional view showing a modification of the punch auxiliary tool.

FIG. 10 is a perspective view showing a punch auxiliary tool according to a second embodiment of the invention.

FIG. 11 is a perspective view showing a using state of the punch device.

FIG. 12 is an explanatory diagram showing patterns to be punched by the punch device.

FIG. 13 is a perspective view showing a state wherein a punch and a punch auxiliary tool of the punch device are assembled.

FIG. 14 is a front sectional view of the punch, wherein (a) shows a state where an operating section is slightly pushed down, and (b) shows a state where the operating section is pushed down to the lowest position and the punching operation is completed.

FIG. 15 is a bottom view of the punch auxiliary tool.

FIG. 16 is an explanatory diagram showing a projecting mechanism of projections of the punch auxiliary tool, wherein (a) shows a slide member, (b) shows a projecting member, (c) shows a torsion spring and (d) is a partial sectional perspective view taken along the line C-C in FIG. 15 showing an accommodating portion.

FIG. 17 is a perspective view showing state (initial state) where a holding member of a positioning tool is brought up.

FIG. 18 is a perspective view showing a state where the holding member is brought down.

FIG. 19 is a perspective view showing a state (exposing state) where a ruler member of a positioning tool is retracted to a back surface of a mounting stage.

FIG. 20 is a sectional view taken along the line D-D in FIG. 17.

FIG. 21 is an explanatory view showing a modification of the projecting mechanism, wherein (a) shows a slide member, (b) shows the projecting member and a coil spring, and (c) is a partial sectional perspective view taken along the line C-C in FIG. 15 showing an accommodating portion.

### EXPLANATION OF REFERENCE NUMERALS

1 punch
3 punch auxiliary tool
7 positioning tool
10 punch station
11 slit
12 guide hole
13 punching blade
14 flange
16 operating section cover
17 projection
18 spring
19 movable wall
20 housing
21 upper housing
22 lower housing
23 gap
25 opening
26 opening
27 guide wall
28 projection guide groove
30 auxiliary tool station
31 opening (inserting/detaching opening)
32 holding portion
33 opening
34 rib
35 non-slip pad
36 arm
38 reinforcing member
39 screw
40 pressing operating member
41 pressing section
42 projecting portion
43 pivot portion
44 rib
45 engagement groove
46 recess
50 projection (to-be-retained portion)
51 projecting member
52 mounting hole
53 inclined portion
55 small hole
57 mounting hole
60, 160 projecting mechanism
61 cover
62, 162 operating section
63, 163 slide member
64, 164 torsion spring, coil spring
65 moving piece
70 mounting stage
71 pivotally supporting shaft
72 accommodating portion
73 pivotally supporting recess
74 rail
75 hole (retaining portion)
80 ruler member
82 ruler portion
83 step
90 holding member
92 mounting piece
93 fixing plate
94 handle
95 holding mechanism
96 link piece
97 slide path
100 punch device

### BEST MODE FOR CARRYING OUT THE INVENTION

Preferred embodiments of the present invention will be explained based on the accompanying drawings. The punch device of the invention is not limited to later-described materials, shapes and configurations, and other selections may be made if the object of the invention is achieved.

### FIRST EMBODIMENT

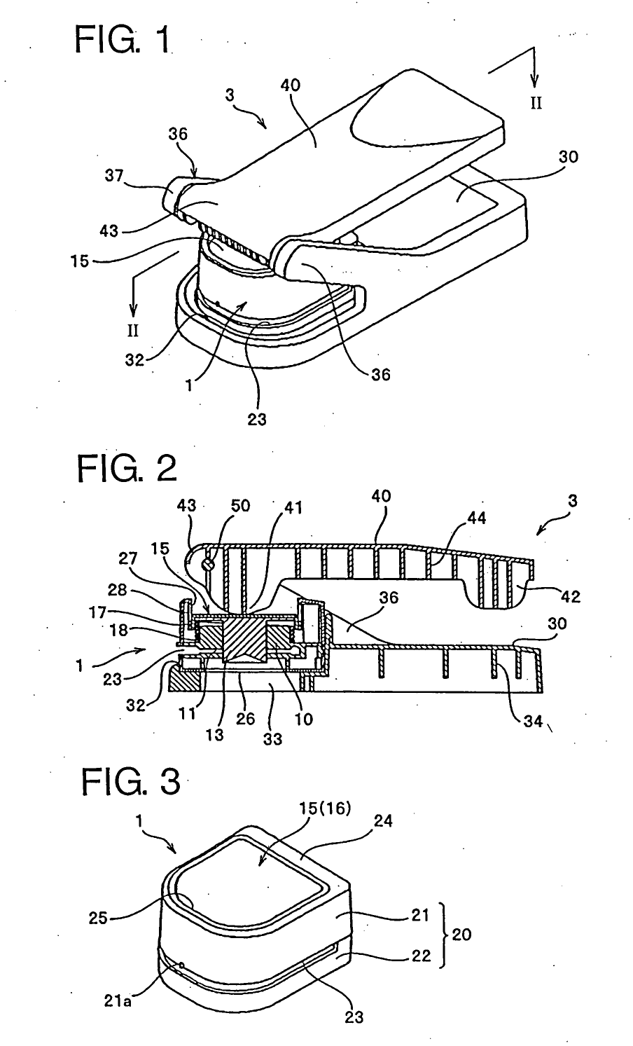

A punch device 100 according to a first embodiment of the present invention is for punching a hole of desired shape in a sheet material such as paper, cloth and synthetic resin, and for forming a cut-out piece of desired shape. The punch device 100 includes a punch 1 and a punch auxiliary tool 3 as shown in FIG. 1.

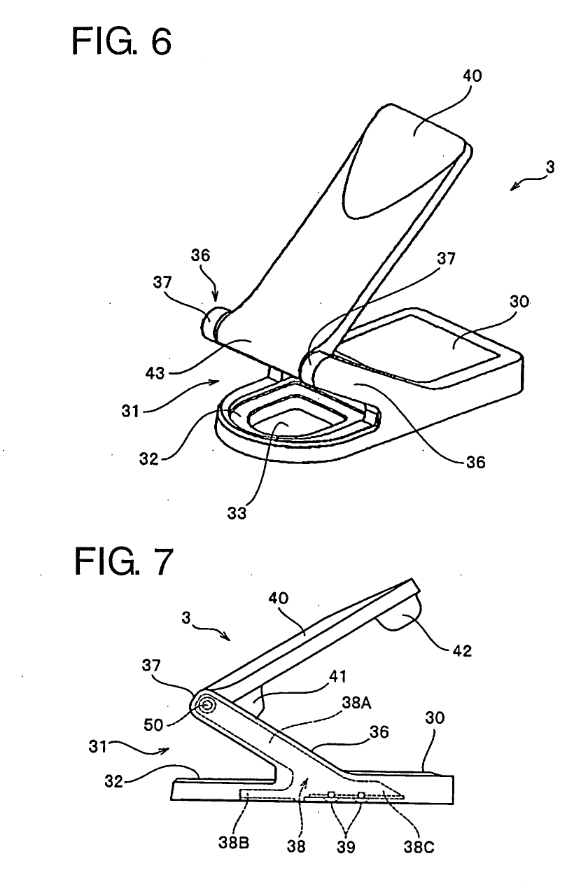

The punch device 100 is used in a state where a punch 1 is inserted from an inserting/detaching opening (opening 31 formed between an auxiliary tool station 30 and a pivot portion 43 of the pressing operating member 40 in FIGS. 6 and 7) of the punch auxiliary tool 3, and the punch 1 is held in a recessed holding portion 32 (see FIGS. 6 and 7) of the punch auxiliary tool 3.

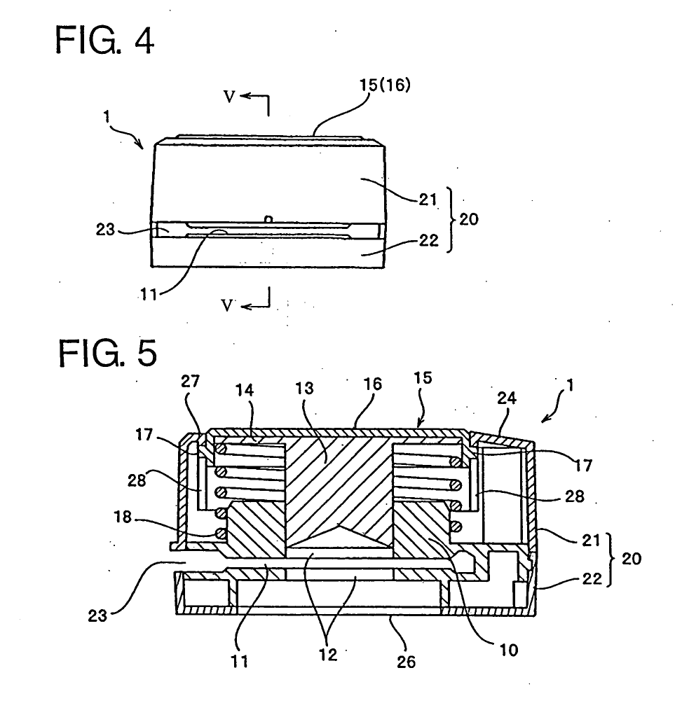

As shown in FIG. 3 to 5, the punch 1 can be detached from the punch auxiliary tool 3 and can be used alone.

First, the punch 1 will be explained with reference to FIGS. 3 to 5.

The punch 1 includes a punch station 10, a punching blade 13, and a housing 20 accommodating an assembly of the punch station 10 and the punching blade 13.

The housing 20 is made of appropriate synthetic resin material, and the outside shape of the housing 20 is rectangular in which both front angle portions are formed into a large arc as viewed from the above, and formed into a substantially flat shape as viewed from side. Its inner shape is similar to the outer shape.

The housing 20 includes an upper housing 21 and a lower housing 22 so that the housing 20 can be divided vertically, and a gap 23 is formed between the connecting portions of the housings so as to correspond to a slit 11 of the punch station 10.

The gap 23 can be formed by shallowly notching an upper portion of the lower housing 22 from its front side toward its rear side and joining the upper housing 21 thereon.

A projection (center reference mark 21a) for indicating a central portion is formed on a side surface of a front portion of the upper housing 21. The upper surface 24 is formed with an opening 25 having a similar shape to the upper surface 24 as viewed from above.

Around the entire periphery of the opening 25, the upper housing 21 is integrally provided with a guide wall 27 so as to hang from the inside of the upper housing 21. The guide wall 27 guides the operating section (i.e., outer peripheral surface of the operating section cover 16) of the later-described punching blade 13.

The guide wall 27 is formed downwardly from the entire periphery of the opening 25 of the upper housing 21. The guide wall 27 is constituted such that when the upper surface of the operating section cover 16 (i.e., the operating section 15) is pushed downward, no gap is formed between the guide wall 27 and the operating section cover 16 so as to prevent a case in which a finger or the like is caught in the gap. The length of the guide wall 27 is set to such a value that a later-described projection guide groove 28 can be formed.

As shown in FIGS. 2 and 5, the projection guide groove 28 is formed in an abutment surface of the guide wall 27 with respect to the operating section cover 16 for limiting a projecting height of the operating section cover 16 from the opening 25 in cooperation with a projection 17 formed on a lower portion of the operating section cover 16. As shown in FIG. 2, the length of the projection guide groove 28 is set to such a value that the projection 17 of the operating section cover 16 does not come out from a lower end of the projection guide groove 28 in a state where the punching blade 13 is pushed down and comes to a substantially lowermost end (i.e., in a state where a spring 18 is substantially fully compressed).

A lower surface of the lower housing 22 is also formed with an opening 26 so that a cut-out piece of the sheet falls from the opening 26.

The punch station 10 is made of zinc metal or the like. The punch station 10 is provided at its lower portion with a slit 11 in the horizontal direction. A sheet is inserted into the slit 11. The punch station 10 is also formed with a guide hole 12 substantially in the vertical direction for slidably guiding the punching blade 13 so as to intersect with the slit 11. A cross section shape of the guide hole 12 is the same as a cross section shape of the later-described punching blade 13 so that the punching blade 13 is guided while keeping in contact with an inner wall surface of the guide hole 12.

The punching blade 13 is made of the same material as that of the punch station 10. A cross section shape of the punching blade 13 is figure of circular, triangular, square or star-like shape, a numeric or a symbol, characters such as alphabet, a pattern such as animal and flower, or combination thereof. By forwardly pushing this punching blade 13 perpendicularly to a sheet such as paper, synthetic resin, fiber, metal and skin, it is possible to punch a hole of desired shape in the sheet, and to form a cut-out piece of desired shape.

A lower end of the punching blade 13 (i.e., a blade edge) cooperates with an angle portion at which the slit 11 of the punch station 10 and the guide hole 12 intersect with each other (i.e., a portion which functions as a lower blade). With this, it is possible to punch a hole of a desired shape in the sheet inserted into the slit 11.

The punching blade 13 is formed at its upper end with a flange 14. The spring 18 is interposed between a lower surface of the flange 14 and an upper surface of the punch station 10 in a state where the punching blade 13 is inserted into the guide hole 12 of the punch station 10. The spring 18 is assembled in a state where the spring 18 is slightly compressed (see FIG. 5). The spring 18 is designed such that the spring is substantially fully compressed if the punching blade 13 is pushed down.

The substantially cylindrical operating section cover 16 is put on the flange 14 of the punching blade 13 so as to cover the entire flange 14 from above. An upper end of the operating section cover 16 is closed. In a state where the operating section cover 16 is mounted on the flange 14 of the punching blade 13, the operating section cover 16 is slidably guided along the guide wall 27 of the housing 20.

As shown in FIGS. 2 and 5, the operating section cover 16 is formed with the projection 17 which limits a projecting height of the operating section cover 16 from the opening 25 of the upper housing 21 in cooperation with the projection guide groove 28 formed in the guide wall 27. In a state where the punch 1 is assembled as shown in FIG. 5, the projection 17 abuts against an upper end of the projection guide groove 28 to limit upward movement, and in a state where the punching blade 13 is pushed down as shown in FIG. 2, the projection 17 is moved to a position where the projection 17 does not come out from a lower end of the projection guide groove 28.

The shape of the operating section cover 16 is the same as the opening 25 of the upper housing 21 as viewed from above. It is preferable that the shape of the flange 14 of the punching blade 13 is the same as that of the opening 25.

Material of the operating section cover 16 may be the same as that of the housing 20, but since the operating section cover 16 abuts against a pressing section 41 of the pressing operating member 40 in the later-described punch auxiliary tool 3 when punching a hole in a sheet, it is preferable that the operating section cover 16 is made of material such as synthetic resin having wear resistance and small friction coefficient.

A method for assembling the punch station 10, the punching blade 13 and the housing 20 to constitute the punch 1 will be explained.

First, the spring 18 is interposed between the upper surface of the punch station 10 and the flange 14 of the punching blade 13, the punching blade 13 is inserted into the guide hole 12 of the punch station 10, and the punch station 10 and the punching blade 13 are assembled.

Next, the slit 11 of the punch station 10 is aligned with a notch (a portion where the gap 23 is formed) of the lower housing 22 and in this state, the assembly of the punch station 10 and the punching blade 13 is mounted on the lower housing 22.

The upper housing 21 is mounted on the operating section cover 16, such that the guide wall 27 of the upper housing 21 is aligned with the shape of the operating section cover 16 of the punching blade 13. At that time, the projection 17 of the operating section cover 16 is fitted into the projection guide groove 28 of the guide wall 27, and the operating section cover 16 is held by the guide wall 27 such that the upper surface of the operating section cover 16 (i.e., operating section) is substantially flush with the upper surface 24 of the upper housing 21.

By assembling the punch in this manner, as shown in FIG. 5, the assembly of the punch station 10 and the punching blade 13 can be accommodated in the housing 20 such that the operating section is substantially flush with the upper opening 25 of the upper housing in a state where the operating section is biased upward by the spring 18.

Next, the punch auxiliary tool 3 will be explained with reference to FIGS. 6 to 8.

The punch auxiliary tool 3 includes a station 30, and a pressing operating member 40 which is attached to a pair of arms 36 of the station 30 in a hinged manner such that the pressing operating member 40 can rock around the arms 36.

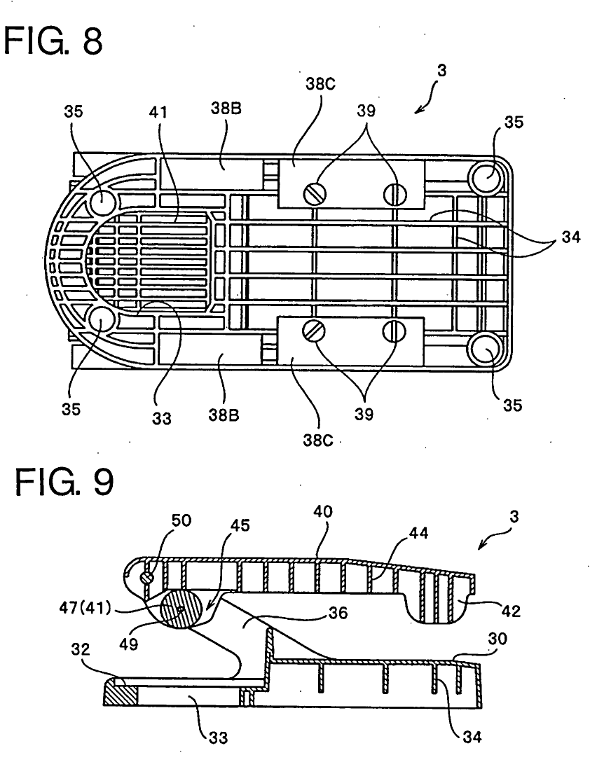

The station 30 is made of synthetic resin or the like. The station 30 is formed into a thin and long shape in which a semi-circular portion and a rectangular portion are connected to each other as viewed from above. As shown in FIG. 8, the station 30 is integrally provided at its back surface with substantially matrix ribs 34 for reinforcement. Holes are formed in four corners of the back surface, and non-slip pads 35 are mounted on the respective holes.

The semi-circular portion of the station 30 is recessed in correspondence with the shape of the bottom of the punch 1. In this recess, the holding portion 32 for holding the punch 1 is formed. The holding portion 32 is provided with an opening 33. This opening 33 is greater than the cross section shape of the punching blade 13, and the cut-out piece of the punch 1 can fall through the opening 33.

Each of the pair of arms 36 of the station 30 is upwardly inclined forward from a substantially central portion of the station 30. A shaft for pivotally supporting the pressing operating member 40 is supported in a tip end of each of the arms 36.

The arms 36 are integrally formed together with the station 30. As shown in FIG. 7, a reinforcing member 38 is disposed on a region of each of the arms 36 which continuously extends from its tip end to its portion connected to the station 30. The reinforcing member 38 is of substantially Y-shaped as viewed from side.

As shown in FIGS. 7 and 8, each reinforcing member 38 includes an arm reinforcing portion 38A for reinforcing the arm 36, a holding portion reinforcing portion 38B for reinforcing the holding portion 32, and a station reinforcing portion 38C for reinforcing a rear portion of the station 30. Connected portions of these reinforcing portions are embedded in the station 30 such that they are located on a mounting portion of the arm 36 with respect to the station 30. In this case, a lower surface of the holding portion reinforcing portion 38B and a lower surface of the periphery of the station have the same height, a step is provided between the connected portions of the holding portion reinforcing portion 38B and the station reinforcing portion 38C, and a screw 39 is inserted into a lower surface of the slightly higher station reinforcing portion 38C, thereby fixing the reinforcing member 38 to the station 30.

By providing the reinforcing member 38 on the region of the arm 36 including the mounting portion of the arm 36 with respect to the station 30, it is possible to handle a load caused when pushing down the pressing operating member 40 which is pivotally supported by the arm 36 to operate the punch 1, and it is possible to prevent the arm 36 and the holding portion 32 from becoming cracked.

A pressing operating member 40 for carrying out the punching operation is disposed between the pair of arms of the punch auxiliary tool. The pressing operating member 40 is made of synthetic resin, and is formed into a flat surface shape that is substantially the same as that of the station 30. Ribs 44 (see FIG. 2) are integrally formed on a back surface of the pressing operating member 40.

A pivot portion 43 is formed on a front end of the pressing operating member 40. A shaft provided on the arms 36 is inserted through the pivot portion 43. With this, the pressing operating member 40 is pivotally mounted on the arms 36 such that the pressing operating member 40 can rock.

The pressing operating member 40 has a portion (41 in FIG. 2) which is in the vicinity of the pivot portion 43 and which projects downward. This portion has such a projecting length that when the pressing operating member 40 is pushed down, the operating section 15 (i.e., the upper surface of the operating section cover 16) of the punch 1 which is held below (i.e., holding portion 32) can be pushed down. This projecting portion constitutes the pressing section 41 for operating the punch.

To prevent the operating section 15 of he punch from being damaged at the time of pressing operation, a protection cover (not shown) made of material having wear resistance and low friction coefficient may be mounted on the pressing section 41.

The pressing operating member 40 is also provided at its rear end with a projecting portion 42 which projects downward. The projecting length of the projecting portion 42 is set to such a value that when the pressing operating member is pushed down, the pressing operating member 40 abuts against the upper surface of the station 10. This design prevents the pressing operating member 40 from being excessively pushed down by the projecting portion 42.

With this configuration of the punch auxiliary tool 3, as shown in FIG. 6, a space (i.e., opening 31) for inserting or detaching the punch can be formed on the side (i.e., front side) where the pressing operating member 40 is pivotally supported. The punch 1 is inserted from this space and the punch 1 is fitted to the holding portion 32 as shown in FIG. 2. With this, the operating section 15 of the punch 1 is pressed by the pressing section 41 provided on the lower surface of the pressing operating member 40 of the punch auxiliary tool 3.

With this design, the punch 1 can be inserted or detached from the side that is opposite to a side where the pressing operating member 40 is operated. Thus, an operator can operate the inserting/detaching operation of the punch 1 using a hand that is not used for pressing operation. Therefore, it is possible to smoothly carry out the series of operations for mounting the punch 1 and punching holes.

The pressing section 41 (point of lever which applies force) which presses the punch 1 is located between the pivot portion 43 (fulcrum) on the front end of the pressing operating member 40 and a rear end (point of lever where force is applied) thereof. Thus, a principle of a leverage can be realized by a compact apparatus.

Especially in the present embodiment, the upper surface (operating section 15) of the operating section cover 16 is substantially flush with the upper surface 24 of the housing 20. Therefore, the pressing section 41 (point of lever which applies force) of the pressing operating member 40 can be brought close to the pivot portion 43 (fulcrum). Since the distance between the fulcrum and the point of lever where force is applied can be shortened, the punch auxiliary tool 3 can be made more compact.

Next, a method of using the punch device 100 according to the embodiment will be explained.

The punch 1 of the punch device 100 can be used alone. First, a method for punching a hole in a sheet using only the punch 1 will be explained.

In the initial state, the punching blade 13 of the punch 1 is located above the slit 11 of the punch station 10 (see FIG. 5). In this state, the sheet is inserted into the slit 11 from the gap 23 of the housing 20.

If the operator presses the operating section 15 (i.e., upper surface of the operating section cover 16) with his or her finger, the punching blade 13 is pushed down. With this, a tip end of the punching blade 13 abuts against the angle portion (i.e., lower blade portion) between the slit 11 and the guide hole 12, and a hole is punched in the sheet inserted into the slit 11 in accordance with the cross section shape of the punching blade 13. At that time, the spring 18 interposed between the punch station 10 and the punching blade 13 is compressed.

Then, the pressing force is released, and the operating section 15 is returned to its initial position by the elastic force of the spring 18.

Next, a method for punching a hole in a sheet using the punch device 100 constituted by assembling the punch 1 into the punch auxiliary tool 3 will be explained.

First, the punch 1 is inserted into an inserting/detaching opening 31 of the punch auxiliary tool 3. At that time, the punch 1 is inserted such that a side of the punch 1 where the slit 11 is not formed is directed toward the punch auxiliary tool 3. A recessed holding portion 32 corresponding to a bottom of the punch 1 is formed below the inserting/detaching opening 31 of the punch auxiliary tool 3. Thus, the punch 1 can be mounted on a position of the punch auxiliary tool 3 where the operating section 15 of the punch 1 abuts against the pressing section 41 of the punch auxiliary tool 3.

In this mounting state, the slit 11 of the punch 1 is located at a front side of the punch auxiliary tool 3 (side where the pressing operating member is pivotally supported), the sheet is inserted from front of the punch device 100, and the pressing operating member 40 is operated, thereby punching a hole in the sheet.

The punch 1 can be mounted and a sheet can be inserted from the same direction. Therefore, when it is desired to punch holes of various shapes in a sheet, it is possible to smoothly carry out the series of operations including the mounting operation of the punch 1, the inserting operation of a sheet and a pushing down operation of the pressing operating member 40.

In the punch 1 of the present invention, the operating section 15 may project upward from the upper surface 24 of the housing 20, and the guide wall may not be provided around the opening 25 of the housing 20.

The holding portion 32 of the punch auxiliary tool 3 may have any shape as long as the holding portion 32 can hold the punch 1, and the holding portion 32 itself may be omitted. The reinforcing member 38 may not be provided, and the pressing section 41 may not be provided with the protection cover.

A roller 47 capable of rotating around the shaft 49 may be mounted on the pressing section 41 of the punch auxiliary tool 3 as shown in FIG. 9. When the pressing operating member 40 is pressed, the roller 47 rotates while keeping in contact with the operating section 15 of the punch 1 (i.e., the upper surface of the operating section cover 16). Therefore, the contact resistance can further be reduced.

The arm 36 of the punch auxiliary tool 3 may have any shape as long as the arm 36 can pivotally support the pressing operating member 40. For example, the arms 36 may stand from the base perpendicularly, or the arm 36 may be of U-shape.

### SECOND EMBODIMENT

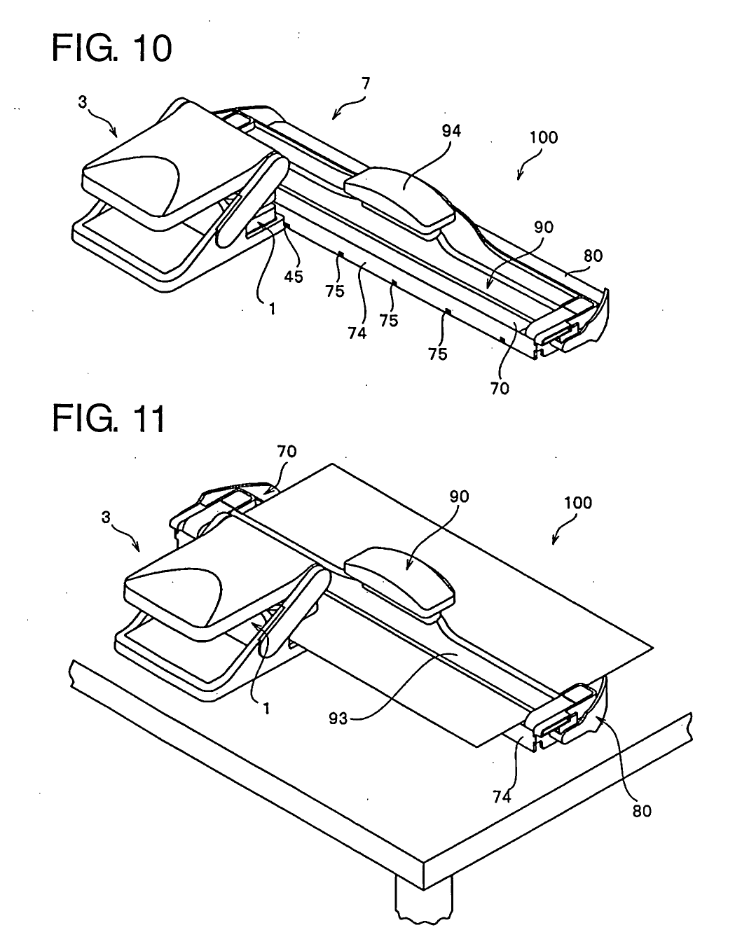

A punch device 100 according to a second embodiment of the present invention will be explained using FIG. 10.

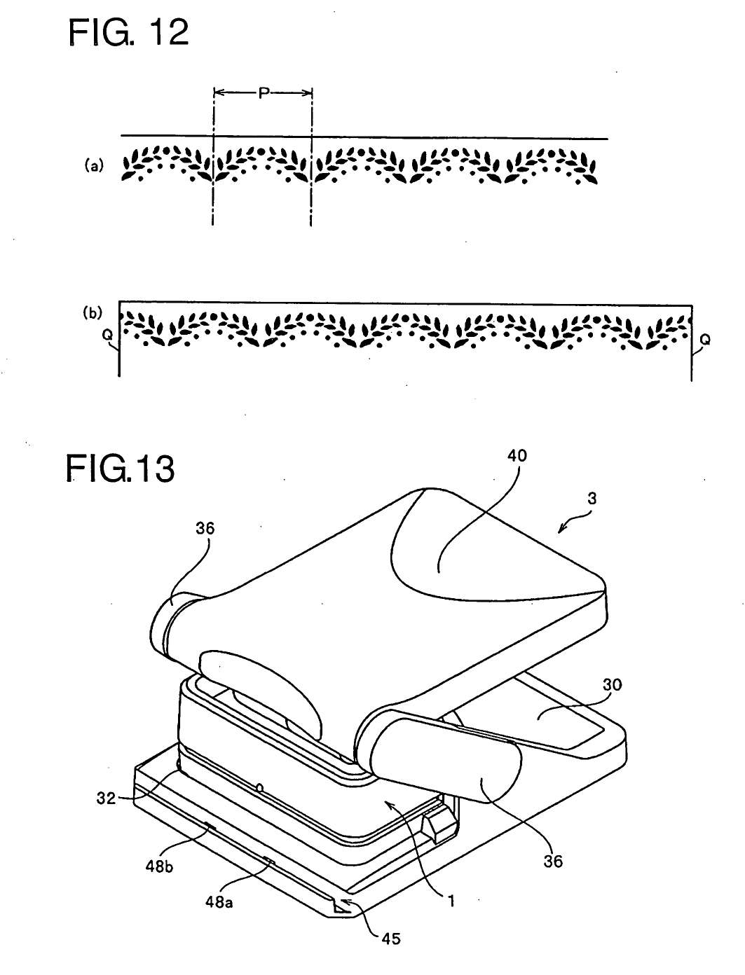

This punch device 100 punches holes along an edge of a sheet as shown in FIG. 11, thereby forming holes having continuous pattern as shown in FIG. 12. The punch device 100 includes a punch 1, a punch auxiliary tool 3 and a positioning tool 7.

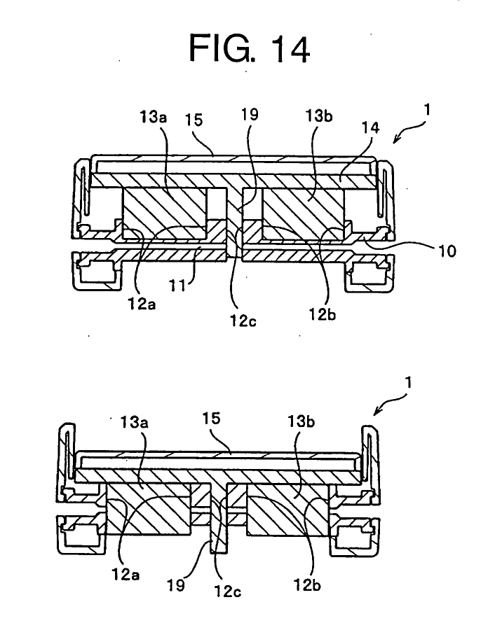

As shown in FIG. 13, the punch 1 of the punch device 100 is the same as the punch of the first embodiment except that an outer appearance of the punch 1 is a laterally long rectangular solid as shown in FIG. 13, the punch 1 is provided therein with a plurality of punching blades 13a and 13b and a movable wall 19 is formed therebetween and the punch station 10 is provided with a plurality of guide holes 12a, 12b and 12c as shown in FIG. 14.

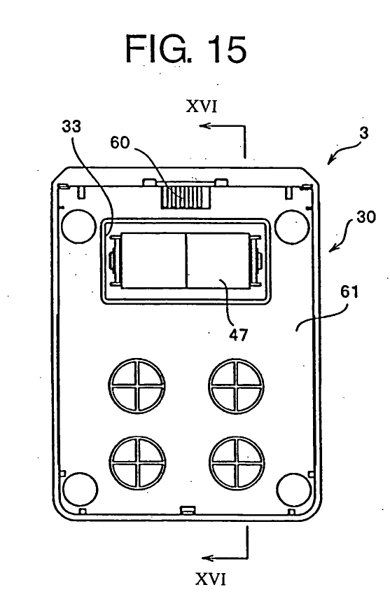

The punch auxiliary tool 3 is the same as that of the first embodiment except that the station 30 is of a rectangular shape as viewed from above, the punch auxiliary tool 3 includes a holding portion 32 having substantially rectangular shape corresponding to the shape of the punch, an engagement groove 45 is provided along a front end edge of the station 30, a projection 50 capable of projecting and retracting is provided inside of the engagement groove 45, and a projecting mechanism 60 for projecting and retracting the projection 50 is provided on a back surface of the station 30 (see FIG. 15).

Structures of the punch and the punch auxiliary tool will be explained below, but the same elements as those of the first embodiment are designated with the same symbols, and explanation thereof will not be provided.

The punch station 10 provided in the punch 1 of the present embodiment is provided with a plurality of guide holes 12a, 12b as shown in FIG. 14. A plate-like flange 14 is integrally mounted on upper ends of the plurality of punching blades 13a, 13b so that the plurality of punching blades 13a, 13b can move forward and backward in the respective guide holes 12a, 12b at the same time. By pressing the flange 14 by the operating section 15, the plurality of punching blades 13a, 13b moves forward in the guide holes 12a, 12b at the same time and can punch a plurality of holes in a sheet inserted into the slit 11.

In the punch 1, the flange 14 is provided at its central portion with the movable wall 19 so that the positioning operation is facilitated when only one or some of the plurality of punching blades 13 are used, and the station 10 is provided with a second guide hole 12c which guides the movable wall 19.

The length of the movable wall 19 is set to such a value that the length is slightly longer than the punching blade 13, and in an initial state where the operating section 15 is not pressed, a lower end of the movable wall 19 is located above the slit 11, and in a preparing state where the operating section 15 is slightly pressed, the lower end of the movable wall 19 is located below the slit 11 as shown in FIG. 14(a). In this preparing state, the tip end of the punching blade 13 is located above the slit 11, and an end of the sheet inserted into the slit 11 is limited by the movable wall 19.

With this structure, when all of the punching blades 13a, 13b punch holes, a sheet can pass through the slit 11 in the lateral direction in the initial state where the operating section 15 is not pressed. When only one or some of the punching blades 13a is used to punch a hole, the end edge of the sheet can be abutted against the movable wall 19 and positioned in the preparing state where the operating section 15 is slightly pressed. With this, when the punch 1 can punch holes having laterally symmetric pattern, it is possible to punch holes using half, i.e., right or left, and this is convenient when a pattern is to be formed on a corner of a sheet.

The punch auxiliary tool 3 of the present embodiment includes the engagement groove 45 for combining the positioning tool 7 and the punch auxiliary tool 3. The engagement groove 45 is designed such that the engagement state between later-described mounting stage 70 and rail 74.

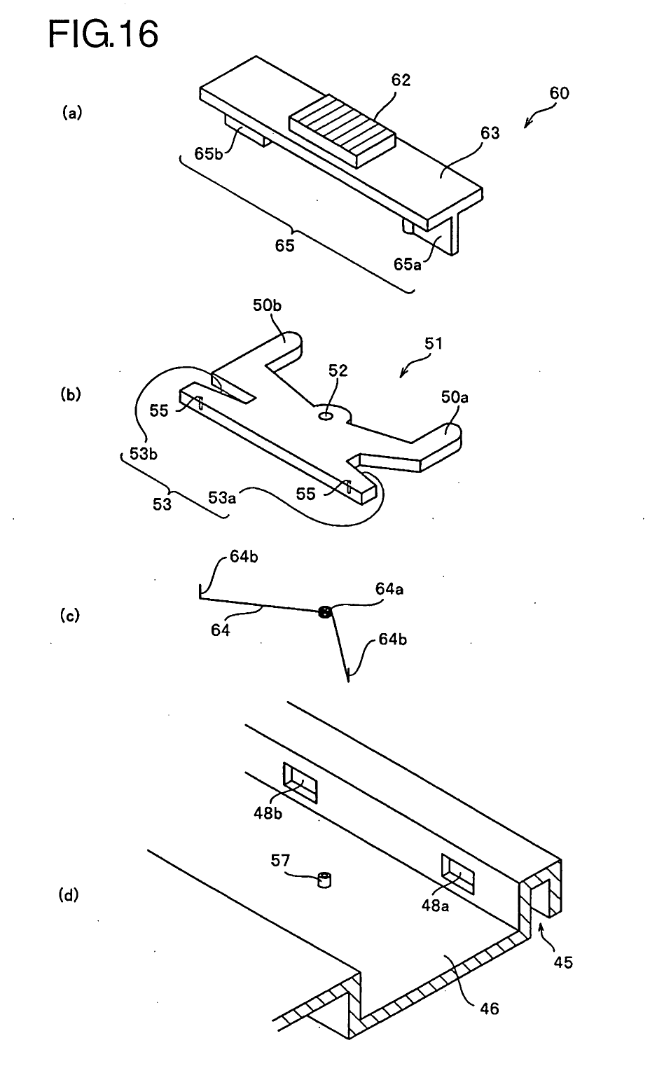

An inner wall surface of the engagement groove 45 is provided with two holes (48a, 48b shown in FIG. 16), and the projection 50 selectively projects or retracts through these holes. The projection 50 engages with a later-described hole 75 of the mounting stage 70, and positions of the projection 50 are switched by the projecting mechanism 60 provided on the back surface of the station 30.

The projecting mechanism 60 provides a half pitch phase difference in an engagement position between the punch auxiliary tool 3 and the mounting stage 70. A structure of the projecting mechanism 60 will be explained.

FIG. 16 shows a state where a cover 61 mounted on the back surface of the station 30 is removed, and the projecting mechanism 60 incorporated therein is exploded. (d) is a sectional view of the back surface of the station 3 taken along the line C-C in FIG. 15.

The projecting mechanism 60 includes a projecting member 51 having two projections 50a, 50b, a slide member 63 for switching positions by laterally sliding the operating section 62 provided on the front surface (surface positioned on a side of the back surface of the station 3), and a torsion spring 64.

The projecting member 51 includes a bifurcate portion having the pair of projections 50a, 50b. A base of the bifurcate portion is formed with a mounting hole 52 which is to be mounted on a cylindrical mounting hole 57 which stands from the punch auxiliary tool 3.

The projecting member 51 is inclined from the base of the bifurcate portion toward the side opposite to the projection 50. A later-described moving piece 65 slides on the inclined portion 53 toward the base and with this, the projecting member 51 turns around the mounting hole 57. Both ends of the inclined portions 53a, 53b are provided with small holes 55 for fixing the torsion spring 64.

The back surface of the station 30 is formed with a recess 46 in which the projecting mechanism 60 is accommodated. The torsion spring 64 and the projecting member 51 are supported in the cylindrical mounting hole 57 which stands on the recess 46. In this case, a ring portion 64a of a central portion of the torsion spring 64 is loosely inserted into the cylindrical mounting hole 57, the small holes 55 of the projecting member 51 are fitted into rising portions 64b on both ends and from this state, the mounting hole 52 of the projecting member 51 is loosely inserted into the cylindrical mounting hole 57.

By fixing the screw to the mounting hole 57, the projecting member 51 and the torsion spring 64 are prevented from coming out from the cylindrical mounting hole 57. The moving pieces 65a, 65b are abutted against the inclined portions 53a, 53b of the projecting member 51, the slide member 63 is assembled, and the cover 61 is mounted on the back surface of the station 30. With this, the assembling operation is completed.

The cover 61 of the back surface of the station is formed with a hole so that the operating section 62 is exposed. In FIG. 16, if the operating section 62 is allowed to slide leftward, the moving piece 65a slides on the inclined portion 53a leftward and with this, the projecting member 51 turns in a clockwise direction, and the right projection 50a retracts from a projecting/retracting hole 48a of the groove, and the left projection 50b projects from a projecting/retracting hole 48b. In this case, a distance between the two projections 50a, 50b is set to a length of half pitch, and if the two projections are allowed to project and retract selectively, the engagement position with the positioning tool can be deviated by half pitch.

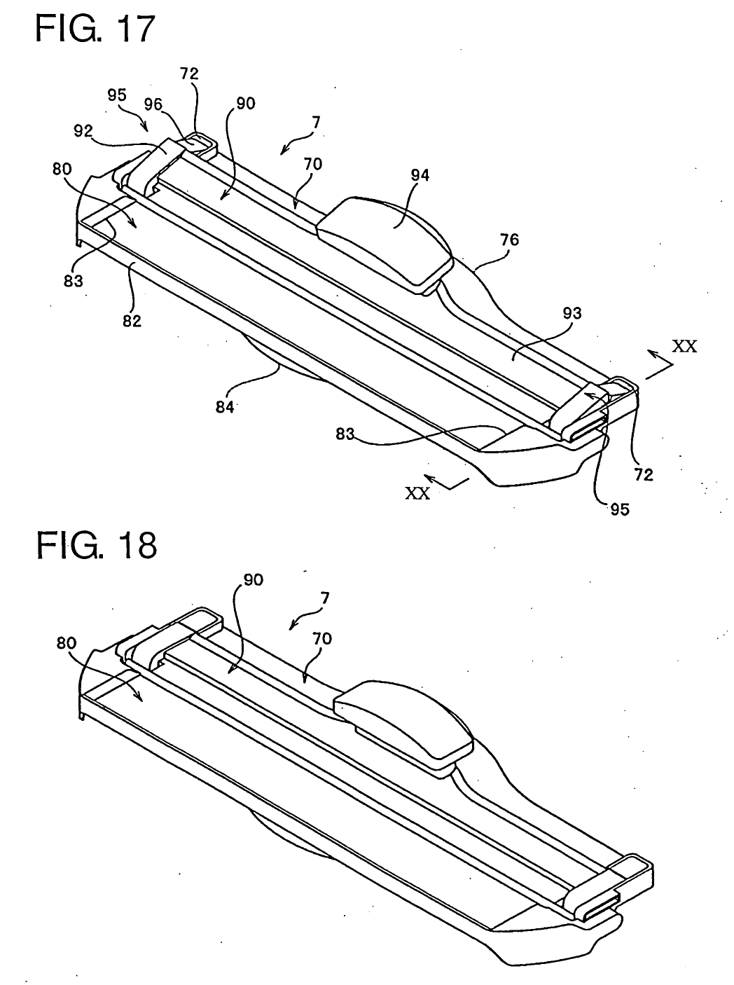

Next, the positioning tool 7 will be explained with reference to FIGS. 17 to 20.

The positioning tool 7 includes a mounting stage 70, a ruler member 80 and a holding member 90 for holding a sheet placed on the mounting stage 70.

A sheet is placed on the mounting stage 70. The mounting stage 70 is formed, for example, with a thin and long plate made of synthetic resin. The mounting stage 70 is formed at its both ends with pivotally supporting shafts 71 (see FIG. 20) for turnably mounting the holding member 90, accommodating portions 72 for accommodating later-described series of holding mechanisms 95 of the holding member 90, and pivotally supporting recesses 73 (see FIG. 20) for turnably mounting the ruler member 80.

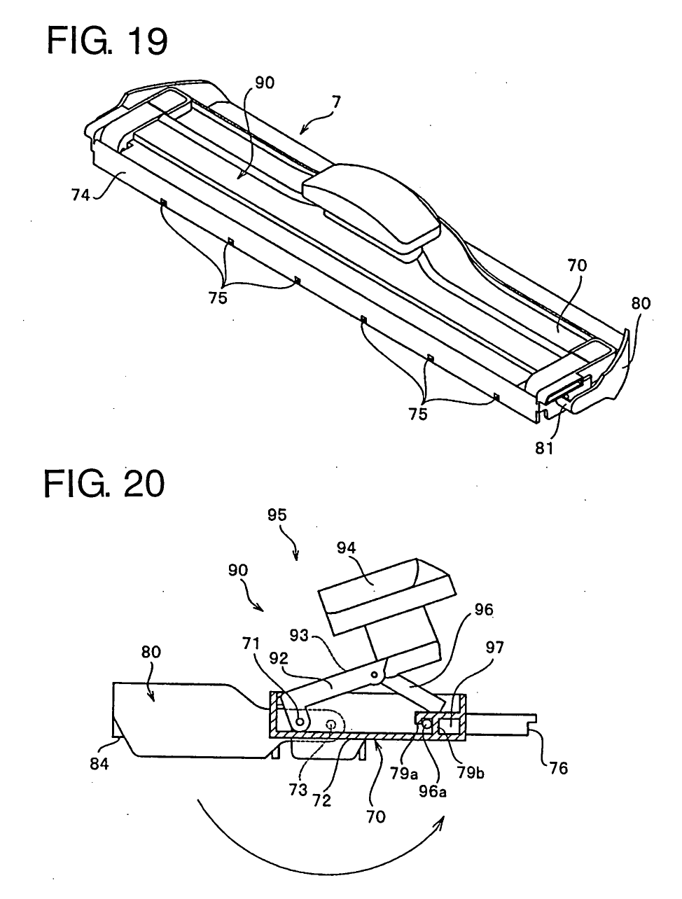

One of side edges 74 (see FIG. 19) of the mounting stage 70 is a slippery surface, and constitutes a rail 74 which is engaged with the engagement groove 45 of the punch auxiliary tool 3. A wall surface of the rail 74 is formed with a plurality of holes 75. The holes 75 engage with the projection 50 of the punch auxiliary tool 3 to set a punching position of the punch 1. The holes 75 are formed at equal distances from one another so that holes are punched in the sheet at equal distances from one another.

Means (e.g., iron plate) which comes into intimate contact with intimate contacting means (e.g., magnet) provided on the holding member 90 is pasted on a predetermined portion of a front surface of the mounting stage 70. A pawl 76 which is fitted to a pawl 84 provided on a back surface of the ruler member 80 is formed on a back surface of the mounting stage 70 as shown in FIG. 20.

The ruler member 80 is for aligning ends of a sheet, and is pivotally supported by the pivotally supporting recess 73 of the mounting stage 70 through a pivotally supporting projection 81 (see FIG. 19). In the initial state shown in FIG. 17, the ruler member 80 is flush with the mounting stage. The ruler member 80 is provided at its side edge opposite to the mounting stage 70 with a ruler portion 82 against which an end of the sheet abuts.

Steps 83 are provided on both ends of the front surface of the ruler member 80. The step 83 has a size corresponding to the sheet for setting a corner of the sheet. The ruler member 80 is provided at its back surface with the pawl 84 which is fitted to the pawl 76 on the back surface of the mounting stage 70. As shown in FIG. 19, the pawl 84 makes the ruler member 80 fit to the pawl 76 on the back surface of the mounting stage 70 when the ruler member 80 retracts to the back surface of the mounting stage 70, and integrally forms the ruler member 80 and the mounting stage 70 together.

The holding member 90 is a member for fixing a sheet placed on the mounting stage. The holding member 90 is pivotally mounted through a pivotally supporting shaft 71 of the mounting stage 70. The holding member 90 has a pair of mounting pieces 92 which are turnably mounted on the pivotally supporting shaft 71, and a thin and long plate (fixing plate 93) is provided between the mounting pieces 92. The fixing plate 93 is provided at its upper surface with a handle 94, and is provided at its lower surface with the intimate contacting means (magnet which is not illustrated) with respect to the mounting stage 70.

The fixing plate 93 is provided at its both ends with holding mechanisms 95 for holding the sheet on the mounting stage 70.

The holding mechanisms 95 are provided for efficiently carrying out the series of operations including the inserting operation of a sheet between the mounting stage 70 and the fixing plate 93, and the fixing operation of the sheet positioned by the ruler member 80 by means of the holding member 90. As shown in FIG. 20, each of the holding mechanisms 95 includes the mounting piece 92 pivotally mounted on the mounting stage 70, a link piece 96 pivotally mounted on a turning end of the mounting pieces 92 through a turning support shaft, and a slide path 97 on which a turning end 96a of the link piece 96 slides.

FIG. 20 is a sectional view taken along an inner wall surface D of the mounting stage 70. The structure of the holding mechanisms 95 will be explained with reference to FIGS. 17 to 20.

A slide path 97 on which the turning end 96a of the later described link piece 96 slides is formed on the inner wall surface D of the accommodating portion 72 of the mounting stage 70 on which the holding mechanism 95 is disposed. The end of the slide path 97 is provided with an end stopper 79a, and a wall 79b is provided on an intermediate portion (position where the turning end 96a of the link piece 96 is fitted from the end stopper 79a).

The height of the wall 79b is set to such a value that when the handle 94 is brought up, the turning end 96a of the link piece 96 can jump over by the elastic deformation. Since the turning end 96a of the link piece 96 is fitted between the end stopper 79a and the wall 79b, the initial state shown in FIG. 17 is maintained when the handle 94 is brought up and the mounting pieces 92 is separated from the mounting stage 70. In this state, a gap into which a sheet enters is formed between the fixing plate 93 and the mounting stage 70.

A sheet is inserted into the gap and the positioning operation is carried out using the ruler member 80. Then, the handle 94 is pushed down and the mounting pieces 92 are brought into intimate contact with the mounting stage 70 (see FIG. 18). At that time, the fixing plate 93 is brought into intimate contact with the mounting stage 70 by the intimate contacting means provided on the lower surface of the fixing plate 93, and the sheet on the mounting stage 70 is fixed.

If the ruler member 80 is turned downward as viewed in the drawing, the rail 74 of the mounting stage 70 is exposed as shown in FIG. 19. The ruler member 80 retracted toward the back surface of the mounting stage 70 is fitted to the pawl 76 provided on the back surface of the ruler member 70. With this, the ruler member 80 is integrally coupled to the mounting stage 70.

A method for forming holes of continuous patterns as shown in FIG. 12 using the punch device 100 having the above-described structure will be explained.

First, punching position of a sheet is fixed by the positioning tool 7. In this case, in FIG. 17, a sheet is inserted between the mounting stage 70 and the fixing plate 93, and an end of the sheet is allowed to abut against the ruler portion 82 of the ruler member 80. The handle 94 is pushed down to fix the mounting stage 70 by the fixing plate 93.

Then, if the ruler member 80 is turned downward, the end of the sheet is exposed (exposed state) in a state where the end of the sheet is in parallel to the rail 74 of the mounting stage 70. In this state, the engagement groove 45 of the punch auxiliary tool 3 is engaged with the rail 74 of the mounting stage 70 (see FIG. 10), and the projection 50 provided in the engagement groove 45 of the punch auxiliary tool 3 is engaged with the holes 75.

Then, if the punching operation is carried out while sequentially engaging the punch auxiliary tool 3 with the holes 75 along the end 74, the continuous pattern holes as shown in FIG. 12 are formed. In this case, the punch is designed such that a bottom surface of the positioning tool 7 in the exposed state (i.e., the upper end of the ruler member 80) is at the same height as the bottom surface of the punch auxiliary tool 3. As shown in FIG. 11, the positioning tool 7 is placed on an operating stage or the like, and the punching operation can be carried out while sliding the punch auxiliary tool 3.

Next, a method for creating phase difference when the continuous pattern holes are formed by the punch 1 having the punching blade 13 having the pattern shown with P in FIG. 12 will be explained.

As shown in FIG. 12(b), when it is desired to deviate the pattern by half pitch, since the distance between the projections 50 of the punch auxiliary tool 3 is set to half pitch, it is possible to deviate the pattern by half pitch by switching the projection 50.

When it is desired to form a pattern of half pitch at an end Q of a sheet, the sheet end Q is allowed to abut against the movable wall 19 of the punch 1. Thus, it is possible to form the half pitch pattern at the end Q of the sheet.

According to the positioning tool of the present invention, the mounting stage 70 may not be provided with the rail or the hole. In such a case, it is difficult to punch holes at equal distances from one another, but the positioning of the sheet end can be carried out.

Instead of providing the ruler member 80 with the ruler portion against which the sheet end abuts, positioning calibration marks may be provided.

It is not always necessary that the projection of the punch auxiliary tool selectively projects and retracts, and the punch may be provided with the projection.

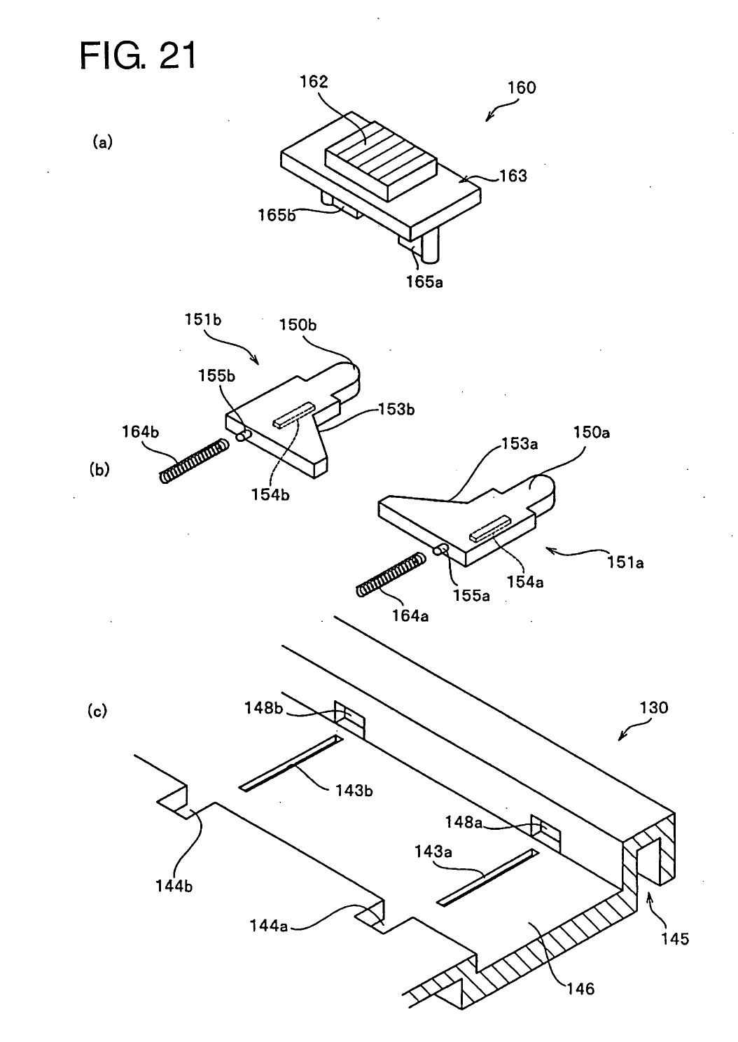

In the projecting mechanism of the punch auxiliary tool, like the projecting mechanism 160 shown in FIG. 21, projecting members 151a, 151b may be provided with projections 150a, 150b, respectively.

In this case, the projecting members 151a, 151b are respectively provided with inclined portions 153a, 153b, and the two projecting members 151a, 151b are disposed so as to be opposed to the inclined portions 153a, 153b. Slide pieces 154a, 154b are provided on back sides of the projecting members 151a, 151b, respectively.

The recess 146 of the punch auxiliary tool 130 is provided with slide grooves 143a, 143b with which the slide pieces 154a, 154b are engaged, and spring mounting portions 144a and 144b. One ends of coil springs 164a, 164b are mounted on the spring mounting portions 144a, 144b, respectively, and the other ends of the coil springs 164a, 164b are mounted on the projections 155a, 155b provided on the projecting members 151a, 151b.

According to this projecting mechanism 160, the moving piece 165a slides on the inclined portion 153a leftward by sliding the operating section 162 leftward. With this, the projecting member 151b is pushed rearward (in the direction in which the coil spring 164b is compressed), the projection 150b retracts from the hole 148b, the projecting member 153a is pushed out forward by the biasing force of the coil spring 164a, and the projection 150a moves forward.

### INDUSTRIAL APPLICABILITY

The present invention can be utilized as a punch device for craft or for office use.

1. A punch device comprising:
a punch including a punch station formed with a slit into which a sheet to be punched is to be inserted and a guide hole for guiding a punching blade in a direction intersecting with the slit, the punching blade to be guided by the guide hole, an operating section for operating the punching blade, and a housing which accommodates the punch station and the punching blade and which is formed with an opening in which the operating section is disposed; and a punch auxiliary tool having a pair of arms rising from both sides of the station and a pressing operating member which is pivotally supported by the arms, wherein
an inserting/detaching opening, which is capable of inserting and detaching the punch in such a state that a side where the slit is formed is directed to a side where the pressing operating section is pivotally supported, is formed on the side where the pressing operating section is pivotally supported, a lower surface of the pressing operating member of the punch auxiliary tool is provided with a pressing section which presses the operating section inserted from the inserting/detaching opening.

2. The punch device according to claim 1, wherein in a state where the operating section of the punching blade is disposed in the opening of the housing, the punch station and the punching blade are accommodated in the housing such that the operating section is substantially flush with an upper surface of the housing.

3. The punch device according to claim 1, wherein the punch has a guide wall suspending from a periphery of the opening of the housing for guiding the operating section of the punching blade.

4. The punch device according to claim 1, wherein the station of the punch auxiliary tool is provided with a holding portion for holding the punch disposed below the pressing section of the pressing operating member.

5. The punch device according to claim 1, further comprising a positioning tool including a mounting stage on which the sheet to be punched is placed, and sheet holding means for holding the sheet to be punched placed on the mounting stage, wherein
a to-be-retained portion provided on the punch or punch auxiliary tool is engaged with a retaining portion provided on the positioning tool, and a punching position in the sheet to be punched is set.

6. The punch device according to claim 5, characterized in wherein a ruler is mounted on a mounting stage of the positioning tool, the ruler member includes a ruler portion against which an end edge of the sheet to be punched can abut, the ruler member can turn toward its back surface from a position where a surface of the mounting stage is substantially flush, the end edge of the mounting stage which is exposed when the ruler member is turned toward the back surface of the mounting stage is provided with the retaining portion.

7. The punch device according to claim 5, wherein the retaining portion comprises a plurality of the retaining portions arranged along the end edge of the mounting stage at equal distances from one another.

8. The punch device according to claim 7, wherein a retaining position of the to-be-retained portion which is engaged with the retaining portion can be changed selectively.
